(19) United States
(12) Patent Application Publication
(10) Pub. No.: US 2026/0180617 A1
(43) Pub. Date: Jun. 25, 2026

(54) NOISE CANCELLATION FOR DOMESTIC APPLIANCES

(71) Applicant: FISHER & PAYKEL APPLIANCES LIMITED, EAST TAMAKI, AUCKLAND (NZ)

(72) Inventor: Matheus Bevilaqua, Auckland (NZ)

(21) Appl. No.: 18/864,967

(22) PCT Filed: May 16, 2022
(86) PCT No.: PCT/IB2022/054514

§ 371 Date: Nov. 12, 2024

(51) Int. Cl. H04B 1/525; H02P 6/10; H02P 6/17

(52) U.S. Cl. CPC H04B 1/525; H02P 6/10; H02P 6/17

(57) ABSTRACT

A motor control method for domestic appliances for reducing noise during use of the domestic appliances including laundry machines and kitchen machines. The method obtains a cancellation signal configured to reduce the noise of the domestic appliance, and combines this with the motor control signal configured to control the speed of the motor to form a combined signal, the combined signal is then applied to the motor. The signal parameters of the cancellation signal including any one or more of frequency, phase and amplitude are selected for noise cancellation.

### FIELD OF THE INVENTION

The present invention relates to motor control for domestic appliances and more particularly, though not solely, to reducing noise and/or vibration in domestic appliances. In particular, the motor control system of the invention is suitable for use in laundry machines, including clothes washing machines and drying machine.

### BACKGROUND OF THE INVENTION

Domestic appliances or home appliances commonly have at least one motor configured to rotate a load such as a fan, drum, or spray arm. These may be referred to as motor driven appliances and also include rangehoods, dishwashers, vacuums and air conditioning units. The motor, as the central operating component, or excitation, of the domestic appliance, is often the cause of noise or vibration created by the domestic appliance. Noise, at least above a required level, is undesirable in domestic appliances because it causes distraction or detriment in the user's homes. Therefore, it is advantageous to reduce or ameliorate noise, if possible. In some cases, noise is generated by normal operation of the appliance, and at a least a portion of the noise is unavoidable.

Torque ripple, periodic disturbances of the torque, is one source of unwanted noise. One component of torque ripple is cogging torque, caused by field changes between permanent magnets and iron teeth on the rotor and stator. Other torque ripple components may also be present when current is applied to the stator. Reduction of cogging torque and torque ripple is achievable through motor design, including careful analysis of the motor geometry. However, even with motor design changes to the machine after motor design can introduce further problems.

Motors and motor controllers have electronic and mechanical components. A motor may be designed and produced with a focus on mechanical features, and a separate motor controller may be added as an electronic component, such as on a printed circuit board (PCB). Typically, the mechanical motor or magnetic designer is interested in ameliorating cogging and torque ripple, often achieved by optimizing motor geometry. The design of the motor controller focusses on accurately driving the motor, assuming that the mechanical motor design (including noise and vibration reduction) has been completed.

The above-described domestic appliance, while performing satisfactorily, could be improved by reducing the amount of noise and/or vibration they produce. It is therefore an object of the present invention to provide a method and system for reducing or ameliorating the noise produced by domestic appliances, which will go at least some way towards overcoming the above disadvantages, or which will at least provide the public with a useful choice.

### SUMMARY OF THE INVENTION

According to one aspect the present invention may broadly be said to consist in a method of reducing the noise of a domestic appliance comprising a motor, the method comprising the steps of: Obtaining a motor control signal configured to control the speed of the motor, Obtaining a cancellation signal configured to reduce the noise of the domestic appliance, Combining the motor control signal and the cancellation signal to form a combined signal, and, Applying the combined signal to the motor.

Optionally the step of obtaining a cancellation signal comprises the steps of: identifying one or more frequencies of the domestic appliance; and calculating a cancellation signal dependent on the one or more frequencies.

Optionally the step of identifying one or more frequencies comprises the step of: identifying one or more frequencies at each of one or more motor or load rotation speeds.

Optionally the cancellation signal is configured to reduce the motor excitation which excites the identified one or more frequencies.

Optionally the step of calculating a cancellation signal comprises the step of:
calculating, or selecting, a harmonic of the electrical frequency associated with each of the identified frequencies.

Optionally the step of identifying the one or more frequencies comprises:
monitoring a noise level of the domestic appliance for a plurality of motor speeds.

Optionally the step of identifying one or more resonant frequencies comprises any one or more of the steps of:
Driving the motor at a plurality of motor driving frequencies or speeds;
Measuring a noise of the appliance at each of the plurality of frequencies or speeds; and
Identifying frequencies where noise levels are high relative to neighbouring frequencies.

The plurality of motor driving speeds may be a range of speeds, or may be a set of selected speeds, or spaced apart speeds.

Optionally at least one, or each, of the one or more frequencies is a resonant frequency.

Optionally the cancellation signal comprises a sinusoidal signal, or a plurality of component sinusoidal signals.

Optionally the step of obtaining the cancellation signal comprises any one or more of:
Obtaining a phase of the cancellation signal,
Obtaining an amplitude of the cancellation signal,
Obtaining a frequency of the cancellation signal.

Optionally the step of obtaining the cancellation signal comprises:
Obtaining a phase, amplitude and/or frequency of a plurality of component signals, and
Combining the plurality of component signals to obtain the cancellation signal.
Forming the cancellation signal from a plurality of component signals allows multiple noise excitations to be cancelled, or allows noise reduction to be improved. Where a cancelation signal is described it can be interpreted as a combination of component signals.

Optionally the amplitude of the cancellation signal is 2-5% of the amplitude of the motor control signal. Optionally the amplitude of the cancellation signal is less than 10% of the motor control signal. Optionally less than 7%, Optionally less than 5%.

Optionally the step of obtaining a phase of the cancellation signal comprises any one or more of the steps of:
loading a stored phase for the cancellation signal,
testing one or more potential phases and selecting a phase from the tested phases,
testing one, or a range of, potential phases and selecting a phase from the tested range of potential phases,
testing a range of phases and using an optimisation function to select an optimum phase,
adjusting the phase based on feedback from the domestic appliance, and/or
adjusting the phase based on sensor measurements from the domestic appliance.

These steps can be performed independently of each other and able to obtain a phase independently. However, it is also possible to use a combination of them to generate a phase, which may be more accurate or provide an option.

Optionally the step of obtaining a phase and/or amplitude of the cancelation signal comprises the step of:
using a one or more sensor measurements to adjust the phase and/or amplitude.

Optionally the sensor measurement(s) only adjust the phase.

Optionally each of the one or more sensor measurements is any one or more of an audio measurement, a noise measurement, an electrical measurement and/or vibration measurement.

Optionally each of the one or more sensor measurements is associated with any one or more of: the motor, the load, or the external environment. Optionally a plurality of sensor measurements are used, with one or more sensors on the motor, load and/or external environment. Optionally only one of the motor, load or external environment has a sensor.

Optionally the step of obtaining a cancellation signal comprises the steps of:
Calibrating a cancellation signal function, and
Generating a cancellation signal based on the cancellation signal function.

Optionally the step of calibrating the cancellation signal function comprises the steps of:
Obtaining noise data of the domestic appliance, and
At one or more frequencies obtaining signal parameters for cancellation signal.

Noise data refers to any suitable measurement of noise, for instance overall noise amplitude or a frequency response of noise.

Optionally the signal parameters include any one or more of phase, amplitude, or frequency.

Optionally the signal parameters of amplitude and/or frequency are preconfigured and the signal parameter for phase is configurable.

Optionally comprising the step of recalibrating the cancellation signal function.

Optionally the step of obtaining noise data comprises the step of sensing noise produced by the domestic appliance at a plurality of frequencies.

Optionally the sensing is performed by a sensor, for example an audio or vibration sensor.

Optionally the step of obtaining the cancellation signal comprises:
Obtaining a feedback signal, and
Generating the cancellation signal based on the feedback signal.

Optionally the feedback signal represents any one or more of:
The operating parameters of the machine;
The noise and/or vibration of a component of the domestic appliance; and
The noise and/or vibration of the domestic appliance.

Optionally the feedback signal is any one or more of: An electrical signal; An audio signal; A vibration signal; An error signal.

Optionally the step of obtaining the cancellation signal comprises:
Identifying noise produced by the domestic motor driven appliance, and
Calculating a cancellation signal configured to reduce the excitation of a motor frequency producing the noise.

Optionally the step of calculating a cancellation signal comprises any one or more of:
A look-up table,
A look-up table linking undesirable noise parameters to cancellation signal parameters,
A look-up table linking motor parameters to cancellation signal parameters,
Minimising a feedback signal,
Minimising a sound feedback signal, and/or
Minimising a vibration feedback signal.

The lookup table maybe stored on the controller, and may be calibratable or updatable, for instance by a user.

Optionally the cancellation signal is configured to reduce the cogging torque of the motor.

Optionally the frequencies of the domestic appliance are determined from the domestic appliance characteristics, the characteristics including any one or more of: Motor dimensions, Motor Cogging, Drum Volume, Diameter, Depth, Fan Size, Motor Type, and/or Load Size, Load Type or Load Weight. Optionally a subset of characteristics is chosen.

Optionally the step of combining the motor control signal and the cancellation signal comprises any one or more of: Adding the signals, or Mixing the signals. Optionally a electrical component is used to combine the signals.

Optionally the motor control signal is a vector control motor control signal.

Optionally the cancellation signal is applied to a motor torque control signal.

According to a further aspect the present invention may broadly be said to consist in a domestic appliance comprising:
A load; A motor configured to operate the load, and A controller configured to: Obtain a motor control signal configured to control the speed of the motor,
Obtain a cancellation signal configured to reduce the noise or vibration of the domestic appliance,
Combine the motor control signal and the cancellation signal to form a combined signal, and
Apply the combined signal to the motor.

Optionally further comprising a sensor, the sensor configured to obtain a measurement, wherein the controller is configured to obtain the cancellation signal based on the measurement.

According toa further aspect the present invention may broadly be said to consist in a controller for a domestic appliance, the controller configured to:
Obtain a motor control signal configured to control the speed of a motor of the domestic appliance,
Obtain a cancellation signal configured to reduce the noise or vibration of the domestic appliance,
Combine the motor control signal and the cancellation signal to form a combined signal, and
Apply the combined signal to the motor.

Optionally the domestica appliance and or controller for the domestic appliance are configured to implement any one or more the optional aspects of the first aspect.

Optionally the cancellation and or motor control signals are any one of voltages or currents and are preferably voltages. The vector control system may comprise a DQ0 control system, wherein the cancellation signals may be combined with Vdx and/or Vqx. Preferably all, or at least a greater signal, is applied on Vqx. Optionally the motor is a permanent magnet synchronous motor. Optionally the motor is a Brushless DC motor. Optionally the domestic appliance is a laundry machine. Optionally the domestic appliance is an extractor unit or rangehood. Optionally the motor load is a rotating load.

According to a further aspect the present invention may broadly be said to consist in method of operating a motor driving a load in a domestic appliance, the method comprising the steps of:
determining a first frequency of a first noise component generated by the domestic appliance at the first speed,
determining a second noise component, the second noise component having a frequency equal to the first frequency but having a phase offset from the first noise component,
determining parameters of an injected signal, the injected signal configured to drive the motor and/or load to generate the second noise signal, and applying the injected signal to the motor.

Optionally the phase offset is 180 degrees. Optionally the injected signal is a torque signal.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The term “comprising” as used in this specification and claims means “consisting at least in part of”. When interpreting each statement in this specification that includes the term “comprising”, features other than that or those prefaced by the term may also be present. Related terms such as “comprise” and “comprises” are to be interpreted in the same manner.

### BRIEF DESCRIPTION OF THE DRAWINGS

FIG. 1 shows a cut-away view of a washing machine

FIG. 2 shows a cross section of a horizontal washing machine

FIG. 3 shows a cross section of a tilt washing machine

FIG. 4 shows a diagrammatic representation of a washing machine

FIG. 5 shows a diagrammatic representation of a washing machine

FIG. 6 shows a control system diagram for a motor of, for example, a washing machine

FIG. 7 shows a control system diagram for a motor of, for example, a washing machine

FIG. 8 shows a control system diagram for a motor of, for example, a washing machine

FIG. 9a shows a control system diagram for a motor of, for example, a washing machine

FIG. 9b shows a control algorithm suitable for use in the control system of FIG. 9a.

FIG. 10 shows a speed vs noise graph for a system without noise cancellation

FIG. 11 shows a speed vs noise graph for a system with noise cancellation.

FIG. 12. shows a cut away view of an extraction unit or rangehood.

FIG. 13. shows a diagrammatic representation of an extraction unit or rangehood.

FIG. 14 shows a speed vs noise graph for a rangehood system out noise cancellation

FIG. 15 shows a speed vs noise graph for a rangehood system with noise cancellation.

### DETAILED DESCRIPTION

Undesirable noise and/or vibration can be caused when there is a source of excitation and another aspect of the system which resonates with the source of noise. In many domestic appliances some noise is unavoidable because it is required to operate the appliance efficiently. However, in other cases a resonance between a vibration generated by the motor and a part of the appliance creates an undesirable noise. It is possible to ameliorate this noise by reducing the vibration(s) generated by the motor. The described methods are applicable to a range of domestic appliances and a washing machine is used only as an example throughout. Applications include laundry machines (including drying machines and multi-function machines) as well as domestic or home appliances.

For example, a washing or laundry machine has an excitation energy or drive of the machine that originates with a motor. The potential resonant components are the other parts of the washing machine, in particular the load(s) attached to the rotor or drive shaft. If the motor frequency (or a harmonic of the motor frequency) operates at or near a resonant frequency of the machine, or part of the machine, the excitation of the motor can resonate with the machine amplifying the noise. For example, the rotation of the tub or drum can resonate with torque ripple in the fields of the motor. Identifying these one or more frequencies (i.e., the frequencies where unwanted noise is produced) allows the method to ameliorate the noise.

Noise may be reduced or ameliorated by avoiding excitation at the resonant frequency(s) of the machine, or by trying to pass through that resonant frequency quickly. However, this may be difficult where the resonant frequency is at or near an important frequency for operation. For instance, there may be a dehydration spin speed at 93 RPM which resonates with the drum. Damping or adding absorbing material to the appliance can reduce the effects of resonant excitation, however these require additional componentry. Alterations to the machine design to change resonant frequencies can also reduce noise, as can improvements to motor design to reduce excitation frequencies or torque ripple.

It has been found that manipulating the motor control signal is a non-mechanical, way to reduce torque ripple and to combat noise in domestic appliances, such as laundry machines. The motor control signal is a signal provided to or controlling the motor which controls or adjusts the electrical power provided to the motor. The motor control signal typically controls the speed of the motor. Providing suitable driving signals (by adding noise cancelling signals to the desired control signals) to electric motor can actively cancel out noise or vibration produced by the laundry machine during operation. It has been found that manipulating the motor control signal at or near particular resonant frequencies (either measured or sensed) of the machine or domestic appliance allow for noise and/or vibration cancellation or at least mitigation. This is partially analogous to active noise cancellation (ANC), as used in audio devices, where a phase shifted copy of incoming noise is used to destructively interfere with, and hopefully cancel, the noise provided improved audio performance. However, because motor driven appliances are not specifically driven for audio output, the noise signal cannot be used directly.

In motor control a fundamental current, signal or excitation is provided to the motor in order to control the speed of the motor by generating torque. In turn the load or loads attached to the motor (either directly or through a drive shaft, belt, gearing or other arrangement are caused to operate or move when the motor is activated) are driven by the rotation of the motor rotor. The fundamental excitation frequency will be selected to generate the required output from the appliance. However, through cogging torque or otherwise, torque ripple can be introduced into the motor alongside the fundamental current. In some cases, this torque ripple excites a resonance of the load, or other parts of the machine, to cause unwanted noise. While noise due to the fundamental excitation cannot be cancelled without reducing performance it is possible cancel noise caused by torque ripple in some cases.

For the example of a laundry machine the main load is laundry drum (although further loads or components able to resonate may also be present). The addition or injection of one, or a plurality of signals (the signals may be an additional voltage or current, or other electrical signals), onto the fundamental current or driving current (or other signal driving the motor operation) produces a further field in the motor windings (on top of the field produced by the fundamental current). If the injected signal is selected, designed, or generated appropriately the field produced by the injected signal can cancel out fields in the motor. In particular, the injected signal can cancel out noise produced by the machine by reducing or cancelling fields in the motor that generate vibrations. If the cancellation is sufficient noise caused by vibration generated by the motor (directly or indirectly) can be avoided or ameliorated, because the vibrational cause (the frequencies or excitations of the motor) has been modified.

The injected signal is preferably relatively small with respect to the driving signal. This avoids efficiency loss (because the injected signal is not intended to drive the output of the motor). In a typical system the driving voltage may be between 250 and 300 Volts and the injected signal may be 0-20 volts, more preferably between 0-15 volts, more preferably 5-15 volts, more preferably 8-12 volts. This is equivalent to the injected signal being between 0-10% of the driving voltage, more preferably between 1-6% of the injected signal, most preferably between 2-4% of the injected signal. The injected signal may be referred to as injected torque, as it is typically fluctuations in the torque of the motor which cause vibrations, although adjustments of non-torque fields are also possible.

It is possible to measure or test or otherwise identify relevant frequencies, such as resonant frequencies, in the domestic appliance. For example, a sweep test, across a range of motor or rotation speeds can be performed and measurements (such as audio measurements of noise, accelerometer measurements of vibration, electrical measurements, or other noise measurements) can be made to identify resonances or potential resonances. The range may be the full range of operation (0 to maximum rpm) or may be a more limited range, or a plurality of ranges which are known to be problematic. The resonances can be determined based on the calculating the central or dominant frequency or frequencies (e.g., those with the highest intensity noise, or apparent noise to a user) of the generated noise. Alternatively, or as well, the resonances can be determined by, or with reference to, the frequency (or RPM (revolutions per minute)) of the motor. In some cases, a known relationship can be used to translate from the motor frequency (rpm) to the resonance frequency.

A domestic appliance or motor driven appliance will typically have a dominant resonant frequency at least one excitation frequency or speed (rpm). The domestic appliance may have different resonances depending on the speed, and in some cases, there may be multiple resonances at the same speed (for instance where resonances are present for multiple harmonics, or different noise producing resonances at a plurality of different speeds. If the load on the motor changes this may affect the resonances. In some cases, this can be positive, because the change in load can help to damp the resonance. However, in other cases where the change in load requires more motor torque this may exacerbate the resonances. Feedback, or recalibration of the control system may be able to address these issues.

The domestic appliance may operate at frequencies where it is not possible to effectively cancel noise. For example, if the resonance and/or noise is occurring at the driving frequency of the motor adding a noise cancellation signal at this frequency will reduce the efficient operation of the motor. Therefore, it may be advantageous to have a set, group or range of frequencies at which noise cancellation does not occur. This set of frequencies may include typical driving frequencies of the motor.

Once one or more frequency(s) producing unwanted noise or resonance have been identified, calculated, or selected the cancellation signal can be generated. The phase and amplitude of the signal injection should be calculated to best ameliorate the noise. However, unlike audio noise cancellation it is not always straightforward to produce signal out of phase with the detected noise. This is because the required injection signal depends on the noise detected but must be generated by the motor. This means the injection signal must account for the transfer function or signal transformation between where the signal is injected and the motor output, which will include the motor itself. Therefore, an injection signal or cancellation signal must be obtained which is configured to make the motor generate an output suitable to reduce the noise producing resonance. Unfortunately, the noise produced by a motor is sensitive to the injected signal; due to the general structure of the motor (for instance number of rotor and/or stator poles) as well as variations in motor construction. This makes it difficult to provide a general transformation from detected noise to injection signal, even for very similar or substantially identical motors.

It is possible to measure a motor speed at which undesirable noise is generated. The motor speed or frequency can then be translated into an electrical frequency of the motor. For a permanent magnet motor the speed is equal to 120*(number of poles)/(Electrical Frequency Fe). For a permanent magnet motor operating at 270 rpm in a 36 pole motor the electrical frequency is 36*270/120˜81 Hz. The noise is likely to be driven by a harmonic of the electrical frequency, for instance the third, fifth or seventh harmonic. This means that the electrical frequency should be multiplied or adjusted to dampen that specific harmonic. Most commonly the cogging torque of frequency equal to the third harmonic frequency will be a cause of noise, as it is the largest harmonic in some motor configurations. Therefore, the frequency of the signal to be injected will be triple the electrical frequency (e.g., 243 Hz). Alternatively, a frequency analysis of the noise produced by motor across a sweep of frequencies (or at a plurality of frequencies of interest) can be used to identify the peak noise frequency at each rotation frequency. In some cases, the one or more frequencies or harmonics could be cancelled, or the harmonic to be cancelled may be chosen based on prior knowledge of the motor and/or appliance resonances. The selection of a frequency could be through the isolation or choice of one or more frequencies where a relatively high noise level is produced. This may be where a particular frequency of noise has a peak, or the overall noise has peaked (either a global or local maximum noise level), or simply a frequency where good noise cancellation is possible. Relatively higher can be measured as a comparison of overall noise level (dB) or noise intensity, or other techniques.

In some embodiments a look-up table or database can be created to associate the phase/amplitude or co-efficient of the signal injection to be used. The look-up table, or tables are stored relationships between the signal parameters and known, measured or available parameters. For instance, they may link measured noise to signal parameters, or motor parameters to noise parameters. The association could be based on any one or more of motor speed, electrical signal, current, voltage, motor type and physical parameters of the domestic appliance. The look-up table may be stored in memory on the controller. The database could be calibrated to be accurate for the particular machine. However, it has been found that the phase of the injection signal (where phase is preferably measured relative to the electrical angle of the motor (θ_{E})) required to reduce noise is often variable or sensitive to small changes between motors. That is to say, it can be highly dependent on the particular motor used and sensitive to small variations in the geometry of the motor parts (i.e., within manufacturing tolerances). While in some cases it may be sufficient to select a phase relative to the current θ_{E} (e.g., 180 degrees), or a fixed phase difference relative to the produced noise, typically the appropriate phase must be tuned, configured or calibrated for a particular motor type, or for each individual motor.

Table 1 demonstrates a series of example successful cancellation (injected) signals for a range of similar washing machines and motors and rotation speeds. While the amplitude of the signals is substantially constant, ranging between 10 and 12 volts for a 250 to 300 volt driving signal the phase angle is more sensitive. Therefore, the system may have a device for adjusting the phase angle of the cancellation signal. This could be performed as a configuration of the machine (i.e., based on an initial test, or maintenance check-up) or may use a closed loop tuning method or optimization (for instance performing a search across possible phase angles and selecting the phase angle which provides the best noise cancellation). In some systems a 2 or 3 dimensional optimization may be performed, so as to as optimise the amplitude and/or frequency (listed in table 1 as harmonic order relative to electrical frequency/θ_{E}). In some examples one or more of the signal parameters are optimised and remaining signal parameters are preconfigured, fixed or pre-set. The more sensitive signal parameters, such as the phase, are preferably optimised whereas more stable parameters (certain frequencies) can be preconfigured. It is also possible to have a plurality of optimised parameters, although this may require additional controller computation. The optimisation can be based on sensor feedback or calibration testing at one or more, or a range of parameter values. The parameter may beset relative to previously used parameters at different speeds or frequencies of the same appliance.

The configuration or calibration of the machine could involve a user, manufacturer, or repairman/serviceman running a configuration test. The configuration test could, at one or more frequencies (RPM) provide input signals of different phase (or, in separate or combined calibrations amplitude and/or frequency (harmonic order or otherwise)) and receive feedback (or noise data) on the best noise cancellation point. The feedback could be through a sensor, such as a microphone, or could be received through a user input, such as a button or through a control application (e.g., a mobile phone application or otherwise). The sensor (or sensors) could be located in or on the machine, including in or on the machine motor. Alternatively, the sensor (or sensors) could be on an external device (such as a personal computer, mobile computer or mobile phone) and a user interface on the machine or external device could be used to confirm or select the best phase angle or configuration. The calibration may involve a sensor on an external device and a user input on the domestic appliance. There may be a communication line or means between the external device and domestic appliance, including wireless or wired communications. The calibration parameters include any parameters of the injected signal, including any one or more of phase, amplitude or frequency.

TABLE 1
Noise cancellation for a range of washing machines

| | | | | | | Cancellation Signal | | |
|---|---|---|---|---|---|---|---|---|
| Washing | | | Ramp | Average SPL (dB) | | Amplitude | Phase Angle | |
| Machine | Motor | RPM | Rate | ANC OFF | ANC ON | (V) | (Degree) | Order |
| TRFL 54 | x2 | 260 | 20 | 51 | 42 | 10 | 210 | 3 |
| TRFL 59 | x2 | 290 | 20 | 58 | 48 | 10 | 210 | 3 |
| TRFL 54 | x2 | 270 | 20 | 58 | 49 | 12 | 45 | 3 |
| TRFL 59 | x2 | 290 | 20 | 57 | 51 | 12 | 45 | 3 |
| TRFL 54 | x2 | 270 | 20 | 60 | 51 | 11 | 90 | 3 |
| TRFL 59 | x2 | 290 | 20 | 59 | 51 | 11 | 90 | 3 |
| TRFL 54 | x2 | 270 | 20 | 59 | 47 | 12 | 75 | 3 |
| TRFL 59 | x2 | 290 | 20 | 60 | 47 | 12 | 75 | 3 |
| TRFL 54 | x3 | 250 | 20 | 60 | 45 | 12 | 120 | 3 |
| TRFL 59 | x3 | 320 | 20 | 59 | 44 | 12 | 120 | 3 |

In the example of the washing machine the drum is the major resonator, or is able to cause the most noise, if it resonates at an excitation frequency of the motor (or a harmonic thereof). Therefore, the parameters of the drum (or alternative largest or most resonant load) may be relevant for calculating or estimating an appropriate noise cancellation injection signal or parameters for the signal. These parameters may include any one or more the diameter, depth, total volume, orientation, material and/or weight of the drum. A combination of these parameters would typically be used. For different appliances the largest rotating body or load connected to the motor or motor shaft may dominate the resonances causing noise. For instance, in an air-conditioner or heat-pump the largest rotating body will be a fan, for a range hood it may similarly be a fan, for a dishwasher it may be a propellor or spray arm. In these cases, the parameters of one or more of the loads attached to the motor or drive shaft, or moved by the motor or drive shaft, will be relevant for associating to the injection or cancellation signal. The parameters may include any one or more of the materials, dimensions, weights or shapes of the loads and/or any relevant parameters listed for the laundry machine.

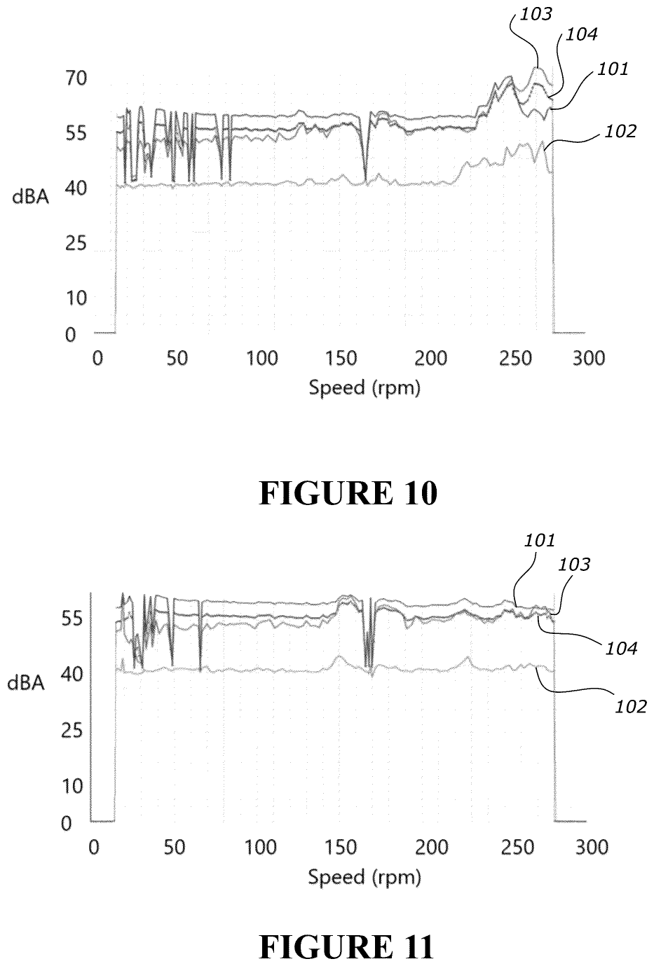

FIG. 10 shows a noise measurement data (in Decibels) for a range of motor or drum rotation speeds between 0 and 300 rpm, similar to that which could be used for calibration. Other noise data may also be used, where it is possible to compare relative noise levels and/or identify peaks or high levels of noise. Noise was measured by microphones located in different areas of the machine. Measurements are shown for microphones outside the machine 102, on or near the suspension assembly or suspension spring 101, and on or near the motor 103. An average of the noise produced is also shown 104. There is a noticeable peak in noise at approximately 270 rpm. Therefore, this would be a frequency of interest. A calibrator could then determine the noise produced was not due to a required function. In this case it was found that the noise was produced by a third harmonic torque ripple, and could therefore be attenuated or reduced. As described above noise at 270 rpm in a 36 pole motor can be excited by a third harmonic of the electrical frequency having a frequency of 216 Hz (prior knowledge may be used to identify the likely or possible harmonic or injection frequency). FIG. 11 shows the result of injecting a cancellation signal at approximately 216 Hz, with an amplitude of around 10-12 volts and an optimised, or partially optimised phase. The noise has been reduced by approximately 10 dB at all locations.

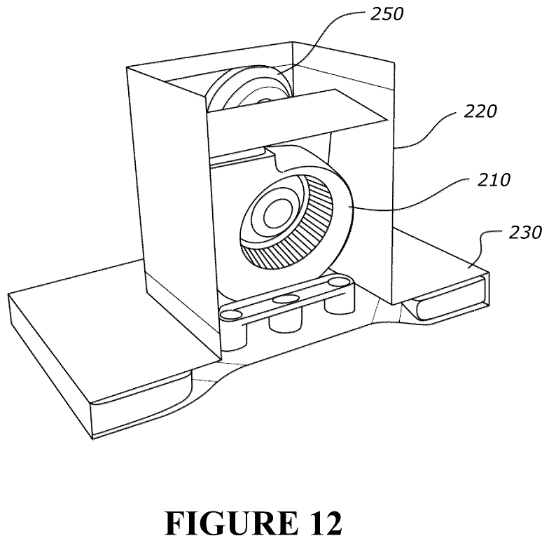

FIG. 12 shows extractor unit 200 that may be installed above a cook top, and may comprise a hood 230 that contains the rising cooking fumes and/or guides them toward an extractor outlet and into the extractor duct 220. The hood 230 may have a T shaped profile, with a portion of the hood 230 that extends substantially parallel with the cook top and connects perpendicular to the extractor duct 220. However, the hood 230 could alternatively have some other profile such as a slanted profiled (with a portion of the hood that extends at an angle relative to the cook top, slanting downward from a rear of the hood to a front of the hood). Various other configurations for an extractor unit hood 130 suitable for the present invention are known in the art.

The extraction airflow may be driven by a blower or fan 210. The fan 210 may be housed inside the hood 230 or an end region of the extractor duct 220, or may otherwise communicate with the extractor duct 220 in order to draw the extraction airflow into the duct. In some embodiments the extractor duct 220 may, comprise multiple ducting sections connected together, or may comprise only a region or part of a ducting section.

The extractor duct 220 may comprise, or be connected to or in communication with, an outlet through which the extraction airflow 2 can be expelled. In some embodiments, the extractor duct 220 may be part of, connected to, or in communication with, a ducting network. The extractor duct 220 may communicate with a central ducting network of a building (e.g., an apartment complex) via which the extraction airflow 2 can be exhausted through a vent of the building. The ducting network may communicate with multiple extractor units, each via a respective extractor duct 220. The extractor unit 200 or rangehood may comprise an electric motor 250 to drive the fan 210. For example, the motor 250 may be housed alongside the fan 210 above the hood 230, and may be coupled to the fan 210 so that rotation of the motor 250 causes rotation of the fan 210.

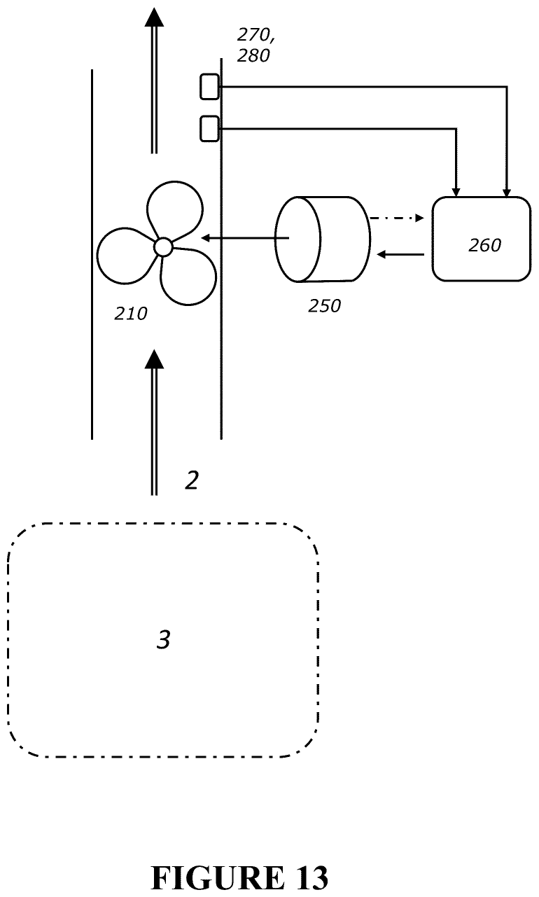

FIG. 13 shows that the extractor unit 200 may further comprise a controller 260. The controller 260 may, among other things, control the motor 250 to drive the fan 210. For example, the controller 260 may control the speed at which the motor rotates (e.g. in RPM). The motor 250 may be controlled to drive the fan 210 to try to achieve a desired flowrate of the extraction airflow 2 (a target extraction airflow flowrate) which is expected to effect adequate extraction of cooking fumes from the cooking region 3. The target extraction airflow flowrate may be between, for example, 6-20 m3/min. In some embodiments the target extraction airflow flowrate may be between 8-14 m3/min. The controller 260 may further be configured to receive and process inputs from various sensors 270, 280 of the extractor unit 1, and/or from the motor 250. Other designs of rangehood are known in the art.

The described method is generally applicable to other domestic appliances which are motor driven, or have motor driven components, such as the extractor unit. The operation of the motor 250 may excite resonances in the rangehood or extraction unit 200, in some cases these resonances create noise which can be cancelled with the described techniques. Similarly, to the laundry machine example there are noises which cannot be cancelled, for instance an operating fan will create noise, however reducing this noise will impact overall performance of the motor. Therefore, one or more frequencies may be chosen at each rangehood fan 210 speeds, and a calculation may of torque ripple frequencies (such as driving current harmonics) which are creating these torque ripples. Injected a signal to reduce these frequencies can reduce overall noise. Sensors 270, 280 can be microphones associated, on or near fan 210, motor 250 or elsewhere in the extractor unit 200 to detect these resonances and allow calibration and/or closed loop control.

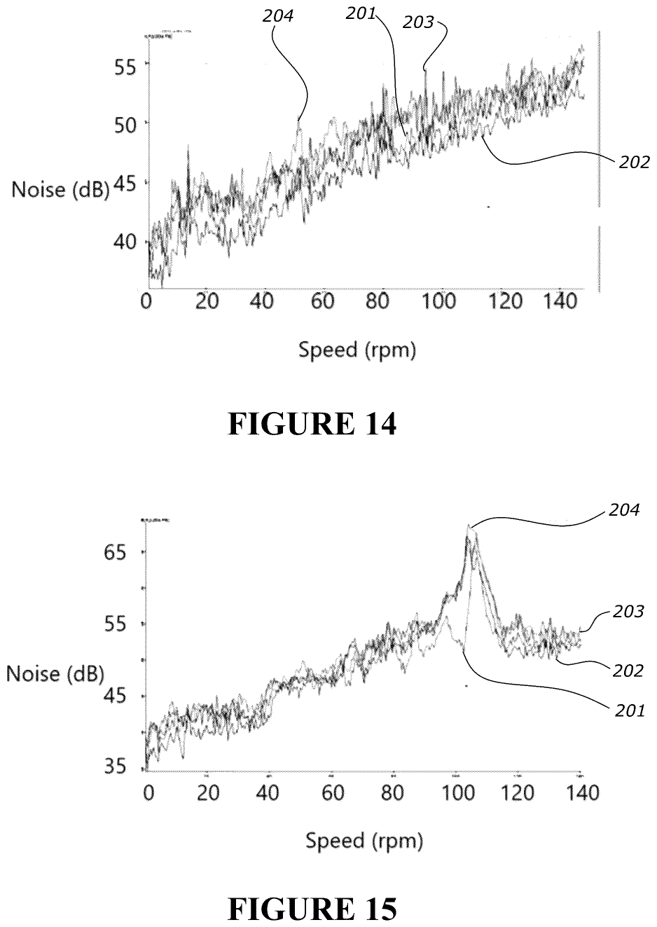

FIG. 15 shows a noise measurement data (in Decibels) for a range of motor or fan rotation speeds of the extractor unit 200. The speed ranges between 0 and 140 rpm, similar to that which could be used for calibration (although a set or plurality of selected frequencies could be used also). Other noise data may also be used, where it is possible to compare relative noise levels and/or identify peaks or high levels of noise. Noise was measured by microphones located in different areas of the machine. Measurements are shown for microphones outside the machine 201, on or near the fan 203, and on or near the motor 204. An average of the noise produced is also shown 202. There is a noticeable peak in noise at approximately 110 rpm. Therefore, this would be a frequency of interest. A calibrator could then determine the noise produced was not due to a required function of the extractor unit 200. We can calculate that noise at 110 rpm in a 36 pole motor the main excitation electrical frequency is 33 Hz. Selecting the third harmonic as the potential cause of resonance a cancelation signal at 99 Hz may be used (prior knowledge may be used to identify the likely or possible harmonic or injection frequency). FIG. 14 shows the result of injecting a cancellation signal with optimised amplitude and phase the noise has been reduced by more than 10 dB at 110 rpm.

Similar methods apply to other domestic appliances with motors driving fans. Dishwashers have a motor (and typically combined or separate pump) operated to rotate a spray arm moving water around the washer (and the pump moving water through the machine). Fridges, freezers and fridge freezers often have a motor driven fan, as well as a motor driven compressor. The described methods are also applicable to domestic appliances with motors that drive one or more loads, where loads include one or more pumps, drive shafts, drums, fans, spray-arms, or other loads useful for the operation of domestic appliances. In several domestic appliances there are multiple motors. Optionally the methods are used to reduce noise produced by first and second motor (or a plurality of motors). This may require multiple microphones or calibrations to determine which noises or resonances are generated by particular motors. In further examples the motor run or operate only part of the machine. For instance, an oven may have a fan-mode which is run by a motor. Noise of the fan-mode may be reducible by the described methods.

In some configurations the motor controller uses vector control (or field-orientated control). In such systems the 3-phase motor control system is transformed into a co-ordinate system having two orthogonal components which rotate with the rotor flux vector. The two orthogonal components generally define a magnetic flux of the motor (Dx) and the torque of the motor (Qx). Field-orientated control allows high-performance motor applications to operate smoothly over the full speed range, generate full torque at zero speed, and have high dynamic performance including fast acceleration and deceleration. In vector control systems it is advantageous to apply the noise cancellation signal to the quadrature axis (Qx, or torque axis) rather than the Direct axis (Dx, stator flux axis). For example, an equivalent voltage applied to the Qx signal can reduce, cancel or ameliorate much more vibration and therefore reduce, cancel or ameliorate more noise than if it was applied at Dx point. Applying the signal at only Qx can reduce the voltage used in the noise cancellation (or required in the injection signal). In alternative systems signals may be applied at both Qx and Dx points, or in different control systems (such as stationary reference (alpha-beta) or 3 phase control). Where different control systems are used the injection signals or noise cancellation signals may need to be modified to provide a similar response to a signal injected at Qx. The required transformations of signals between reference frames are known in the art. In some cases, it may be easier to discuss injecting torque or a torque signal into the motor. It will be understood that an injecting an electrical signal configured to induce a torque or torque field in the motor is equivalent to injecting a torque signal.

In some configurations the motor is a BLDC (brushless direct current) permanent magnet synchronous motor (PMSM). An example motor to which the system could be applied is shown in US20180159394A1. However, the control system can be applied to other motors including induction motors and synchronous motors. Different motors are likely to require changes to the injection signal due to differences between the mechanical and/or electrical properties of the motor. For instance, the relationship between the rpm and frequency will depend on the number of poles of the slip between stator field and rotor filed in an induction motor.

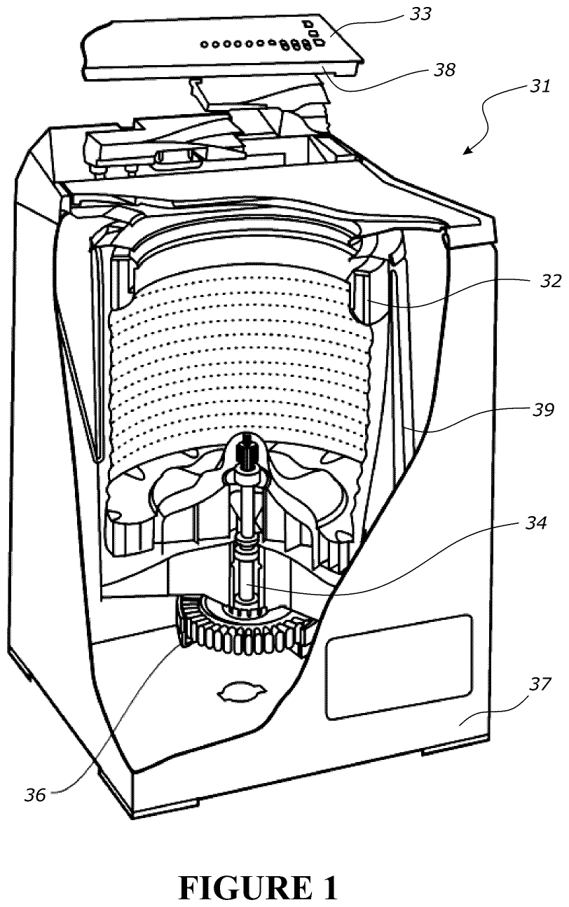

FIG. 1 shows a laundry machine 31. The laundry machine has a body 37 containing a motor 36 connected to 1 drum 32 by drive shaft 34. In use clothes or laundry are placed in the drum and the controller performs the required actions to clean or launder the clothes. Variations of this connection are possible, including where the drum is connected direction to the motor rotor. The orientation of the drum is typically vertical or horizontal, although other orientations are possible. Commonly manufacturers produce several sizes of laundry machines 31 to allow for different drum 32 size (and therefore capacity) and to fit in different spaces. The variation in drum size and other parameters or characteristics of the laundry machine will affect the resonant frequencies of the machine and therefore the noise generation. A control panel 33 is available to a user on the outside of the body 37. The control panel is shown on the top of the washing machine, but may be located elsewhere, or available through an app. The control panel 33 provides input signals or instructions to a controller 38 which controls the mode of operation or parameters of the laundry machine 31. The controller 38 may be a computer or microcontroller or similar device capable of receiving input signals and sending instructions and/or timing signals to the various components of the washing machine, as known in the art. The controller 38 may be located in or near the control panel 33, or elsewhere inside body 37. In some cases, the controller 38 is formed by a plurality of components distributed across the machine.

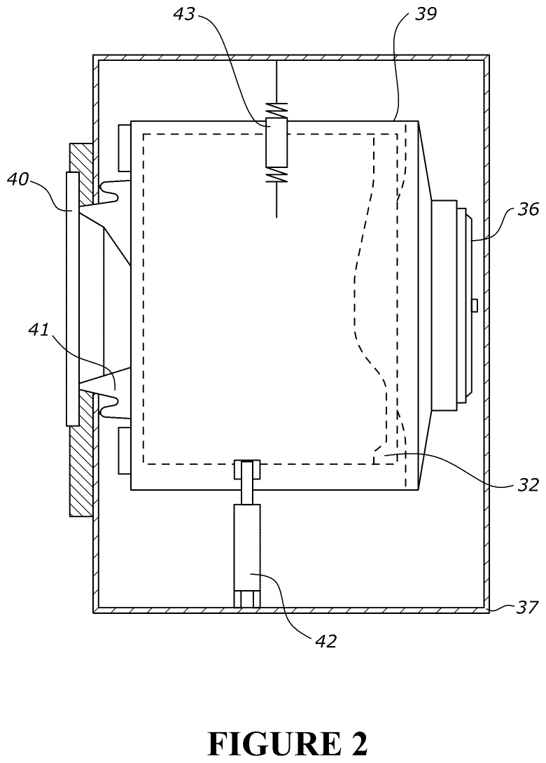

FIG. 2 shows a front loading horizontal axis washing machine 31 with an outer wrapper and a rotating drum housing 39 suspended in the outer wrapper or body 37. A rotating drum 32 is disposed in and rotatable within the rotating drum housing. A door 40 provides access to the rotating drum 32 for introducing or removing clothing to be washed. A gasket 41 may be included to provide a seal between the door and the rotating drum. A rotor is coupled to the rotating drum via a rotational shaft and the stator is coupled to the rear of the tub. The motor 36 can be operated by a controller 38 to spin and oscillate the rotating drum 32 to carry out washing of clothes. The cut-away view shows support features of the drum including support 42 and damping or suspension spring 43. A motor 36 is used to rotate the drum, shown located at the base of the drum to the right of FIG. 2. Alternative placement of the motor 36 is possible, including where the motor is spaced apart from the drum and mechanically connected to the drum by, for instance, gearing or a belt. In all cases the machine can benefit from noise cancellation as described. In some embodiments, resonances due to the drum 32, support 42 or suspension spring 43 may be targeted through noise cancellation. One or more sensors or microphones at or near the drum 32, support 42, or suspension 43 may be used to isolate or target particular noise.

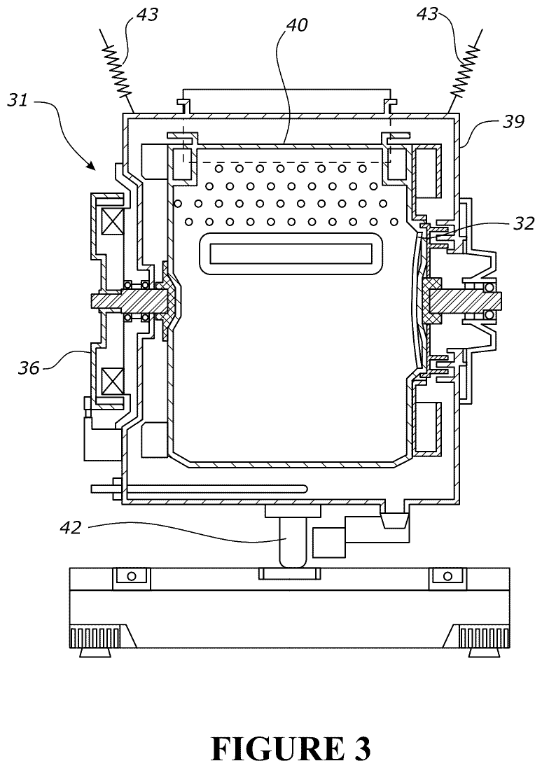

FIG. 3 shows a top loading or tilt access horizontal axis washing machine 31. The washing machine has an outer wrapper (not shown) and a tub 39 suspended within the outer wrapper. A rotating drum can rotate within the tub. Clothes can be introduced and taken from the rotating drum through an opening 40 in the top of the drum. A motor 36, comprising a stator and rotor as, is arranged to drive the rotating drum via a rotational shaft. The motor can be operated by a controller 38 to spin and oscillate the rotating drum to carry out washing of clothes. Similar to FIG. 2, resonances may occur across the machine 31. These include at the supports or suspension locations (or locations where the drum is connected to the frame) as well as the drum itself.

In some cases, it if advantageous to mount microphones or sensors to the domestic appliances. Considering the laundry machines of FIGS. 2 and 3 sensors (such as microphones) could be mounted on any one or more of the motor 36, the drum 32 or tub 39, the support 42, the suspension support 43 or spring, or elsewhere inside or outside of the machine 31. It may be advantageous to have multiple sensors, for instance to determine where a particular sound or noise is being generated, or to compare internal and external noise (noise in the external environment). The sensors may be microphones, transducers, vibration sensors, accelerometers or other devices which provide an indication of noise production.

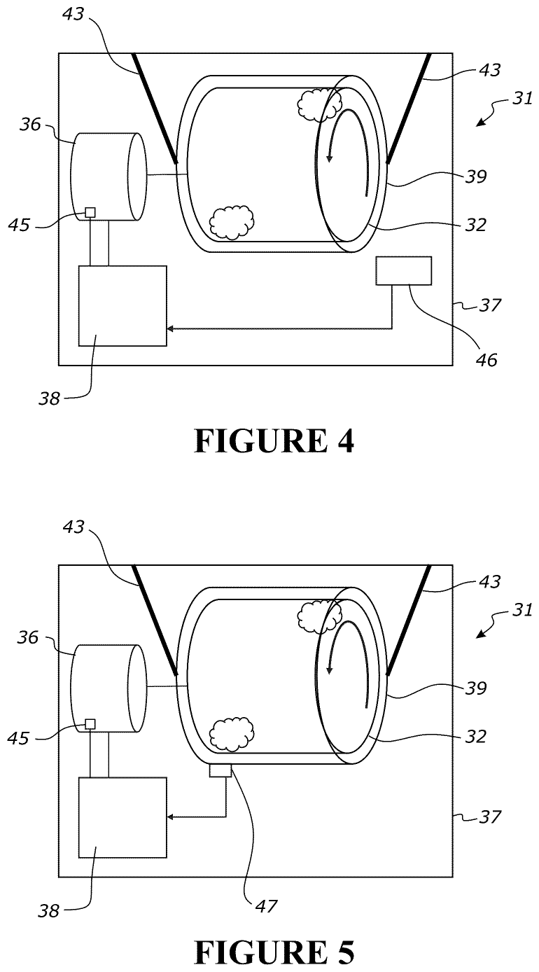

FIG. 4 shows the control features of a laundry machine. The laundry machine has a drum 32 inside a tub 39 inside the body or housing 37 of the machine. The drum 32 is configured to rotate or oscillate during the clothes washing process. The drum 32 is typically mounted or suspended inside the housing by a suspension assembly. The suspension assembly may comprise one or more supports 42 and/or one or more spring mounts 43. The drum may be within a wrapper or drum housing 39 which is adapted to hold water within the drum 32 or support the drum when rotating. The suspension assembly may then be attached to the outer wrapper which holds the drum. The drum is excited or moved by the motor 36. The motor may be of various known types but is preferably a BLDC PMSM. The motor is controlled by a motor controller 38.

One or more sensors may be attached, mounted to or associated with the washing machine. For instance, a motor sensor 45 may provide measurements of motor parameters including any one or more of electrical angle, mechanical angle, motor currents and voltages. Sensors of noise and/or vibration can also be located across the machine. In particular FIG. 4 shows a noise or vibration sensor 46 mounted or located within the body 37. FIG. 5 shows a similar arrangement for a laundry machine but with a noise or vibration sensor 47 mounted to or nearby the drum 32 or tub 39. In other systems a sensor or an additional sensor is mounted externally to the laundry machine 31. One system may have multiple sensors 46,47 mounted in different locations. The preferred location depends on expected noise producing component, as well as the ease of placing a sensor. For example, it is easier to place a sensor on a current PCB or controller (or controller part) than to attach or secure a sensor in a new position. In some embodiments the controller 38 may comprise multiple parts or PCBs distributed around the laundry machine. For instance, there may be a separate PCB for the motor controller 38. While the system has been illustrated with variants of a laundry machine it will be understood that similar systems could be constructed in other domestic appliances, where the motor will be connected to or associated with a different load or loads requiring different configurations or sensor placements.

The motor controller 38, or the portion of controller 38 directed to controlling the motor 36, is configured to control the operation of the motor 36 to meet the requirements set by the user. Typically, this means controlling the rotation speed (ω_{R}, or rpm) of the motor 36 (and therefore drum 32) to allow appropriate spin drying of laundry as well as speed and direction to allow appropriate agitation during the washing and/or soaking phases. A main control system or algorithm will normally receive a desired rotation speed (ω_{R}* as well as measured motor position and speed (Om, ω_{R}), appropriate motor driving signals (for instance Vd* and Vq*) can then be calculated, as is known in the art, e.g., vector or field orientated control algorithms.

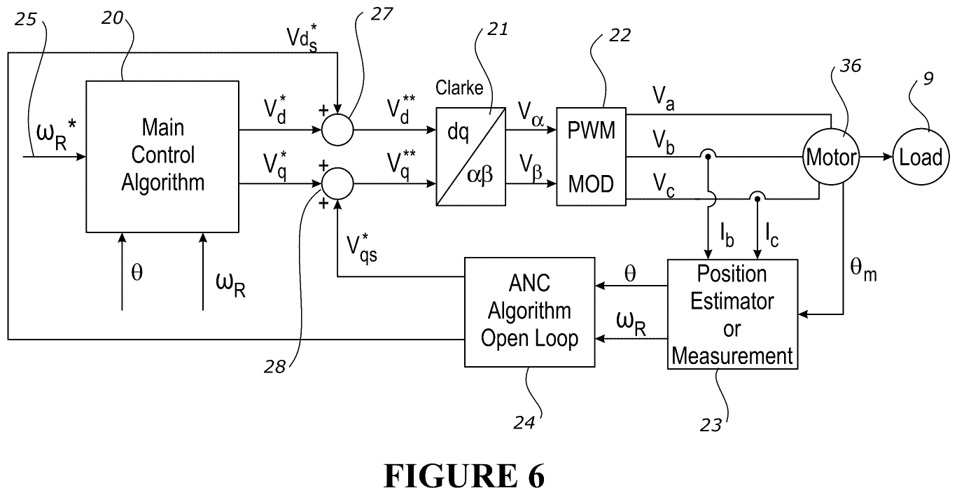

FIG. 6 shows a motor control embodiment wherein the main control algorithm 20 takes an input control signal 25 as well as measured signals for motor position θ and motor speed ω_{R}. The control algorithm 20 calculated vector control signals V_{d}* and V_{q}* which can be transformed by a transformation algorithm 21, for instance a Clarke algorithm, in to the alpha-beta frame (or stationary reference frame), and then by a PWM Modulator 22 converted to input signals to the motor (Vₐ, V_{b}, V_{c}) to the three phase motor 36, which drives or excites the load 9. Other means of applying, associating, or communicating, the combined signal to the motor may be used. The control signals (θ (Electrical position, also referred to as θ_{E}), ω_{R}) can be obtained by a position estimator or measurement device 23. This can take inputs from sensors on the motor (for instance providing position measurement (θₘ), or electrical sensors on the input signals (such as voltage or current meters).

FIG. 6 also shows an additional ANC (active noise cancellation) algorithm controller 24. This control algorithm provides noise and/or vibration cancellation to the overall controller. In one example open-loop control system the ANC algorithm 24 receives the motor position and motor speed (θ, ω_{R}) as inputs and includes a look-up table or pre-built algorithm which calculates suitable noise cancellation signals (V_{ds}* and V_{q}s*). These noise cancellation signals are added or combined with the vector control signals at combiners 27, 28. When transformed and passed to motor 36 the noise cancellation signals (V_{ds}* and V_{q}s*) alter or modify the torque in the motor so as to move or reduce the frequencies or harmonics present which are causing resonance or noise. In some variations there may be a single output signal only connecting to one of vector control signals V_{d}* and V_{q}*. Furthermore, the relative sizes, voltage ranges or intensities of the noise cancellation signals may be varied. In particular it has been found that the relative impact of a voltage is greater when applied to V_{q}* because this applies the voltage directly to the torque producing component.

Preferably the noise cancellation signals (V_{ds}* and V_{q}s*) are sinusoidal signals, such as voltages, which are functions of the electrical position of the motor θ_{E}. An advantage of the noise cancellation signals being sinusoidal is that the amplitude, phase (relative to each other and/or to the motor signals) and frequency provide a set of parameters which can be varied to provide the best noise reducing signal to the motor. The use of sinusoidal signals (or sine waves) also means that an injection signal of varying shape can be formed by a combination of sine waves, for instance in cases where two noise frequencies are being ameliorated at the same time. Each component signal can follow the method as described and be combined with the motor control signal at the same, or different points.

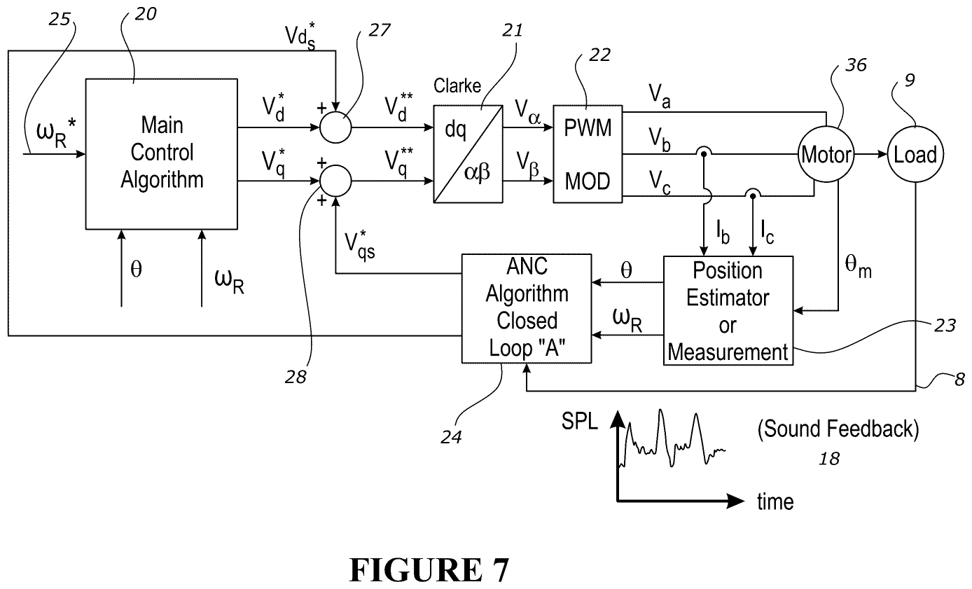

FIG. 7 shows a similar motor control system to FIG. 6 with the addition of a closed loop feedback 8. The core operation of the controller of FIG. 7 is similar to that of FIG. 6, however a sound or audio feedback 18 is now available from the load. While it is expected that the main load (e.g., the drum of the laundry machine) will be the main generator of noise in other systems the noise from the wider machine may be recorded in case further resonances are present. The sound feedback 18 can be obtained from a microphone or other suitable sound recording apparatus or device. Preferably the microphone is located at or near the motor so that it records noise close to the motor or main resonator, and therefore can better measure or “sense” the motor noise. However, it is also possible to locate the microphone remotely, such as on the load, or on the control panel 33. In these cases, the sound or audio signal can be passed to the motor controller 38 by wiring or other known communication techniques. In some cases, a plurality of microphones is used to improve noise collection or to target multiple noise locations. In particular embodiments the microphones are configured to detect the vibrations or noise of the washing machine, or domestic appliance, the vibrations caused by the motor and amplified by the washing machine system. While sound feedback 18 has been described, it is clear that a sensor indicative of sound or vibration could alternatively be used.

The sound or audio feedback 18 received by the active noise cancellation algorithm is used to determine the suitable correction signals (V_{ds}* and V_{q}s*) to combine into the motor drive signal. The signals can be combined by connecting the electrically, either directly or through a component. The feedback 18 will be indicative of a noise of the machine, by adjusting the parameters of the injected signal or noise cancellation signal being applied and monitoring the noise of the machine the parameters of the injected signal which provide the most effect noise cancellation can be obtained. For example, the phase of the injected signal (relative to the electrical position of the motor) may be adjusted between 0 and 360 degrees. This can be used to identify the most effective noise cancellation frequency. If additional knowledge about expected phase was known, then this range could be reduced. Concurrently, before or after the phase was calculated the amplitude could also be calculated. Preferably this would occur concurrently or after the phase because the noise appears less sensitive to amplitude.

The frequency for the injected signal can be calculated based on the motor or drum rotation speed. For example, the rotation speed can be converted to an electrical frequency and one or more harmonic of this electrical frequency selected (such as the 3^{rd}, 5^{th}, 7^{th}) The selection of the harmonic can be based on prior knowledge of which harmonics cause noise for a particular appliance.

More complex feedback systems are also possible. For instance, a spectrum analysis (such as a Fourier spectrum or FFT of the noise signal) can be used to identify the largest frequency components of the sound feedback 18. These can be converted to motor frequencies or compared with motor frequencies to identify particular harmonics causing noise. The correction signals (V_{ds}* and V_{q}s*) can then be configured to alter the motor frequencies so that they motor does not excite at the noise frequencies. This configuration could include performing local or global optimalisation of the amplitude or phase for an injected signal at the calculated frequency. Where the frequency is calculated there may be one or more frequencies or sections of the frequency spectrum which are not used. These would be selected to avoid attempting to cancel noise at operation frequencies. For instance, noise due to the drum rotation, or a fan blade passing through air is unavoidable using noise cancellation at these frequencies is likely to reduce the efficiency of the appliance.

The control system of FIG. 7 allows a closed loop control system, where the control system is constantly monitoring itself (with the microphone or audio transducer, or any other noise or vibration sensor). If a resonance is detected in the sensed measurement a suitable cancellation signal can be generated and applied. It can be useful to ignore some resonances, for instance where attempting to reduce the resonance will detrimentally effect performance of the laundry machine. This can occur if the resonance is at the central operating frequency (i.e., drum excitation frequency). A range, plurality or set of one or more ranges, of allowed and/or disallowed frequencies for noise cancellation signals may avoid this issue.

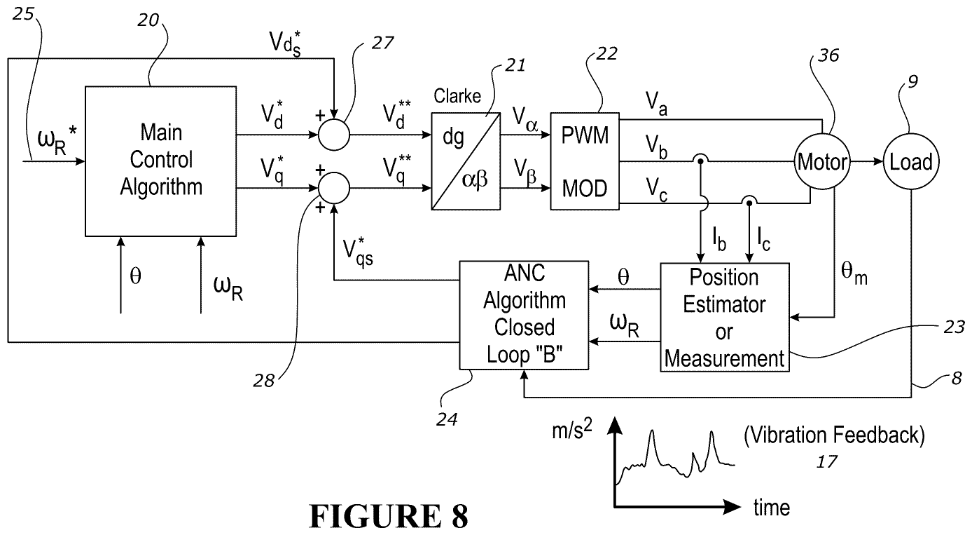

FIG. 8 demonstrates that alternative transducers or sensors can be used. In particular instead of using a microphone to feedback noise a vibration sensor, such as an accelerometer, can be used to sense vibration in or of the washing machine. Electrical sensors can also provide feedback. FIG. 8 shows the closed loop feedback signal is 8 is a vibration signal 17 or feedback. The incorporation of the vibration sensor into the control algorithm is similar to the sound feedback, simply a further or alternative sensor is required and the ANC algorithm 24 must be adapted to vibration. In a similar method as the sound sensor the frequency spectrum, or dominant frequencies of the vibration feedback can be used to create a suitable noise cancellation signal(s) (V_{d}s* and V_{q}s*).

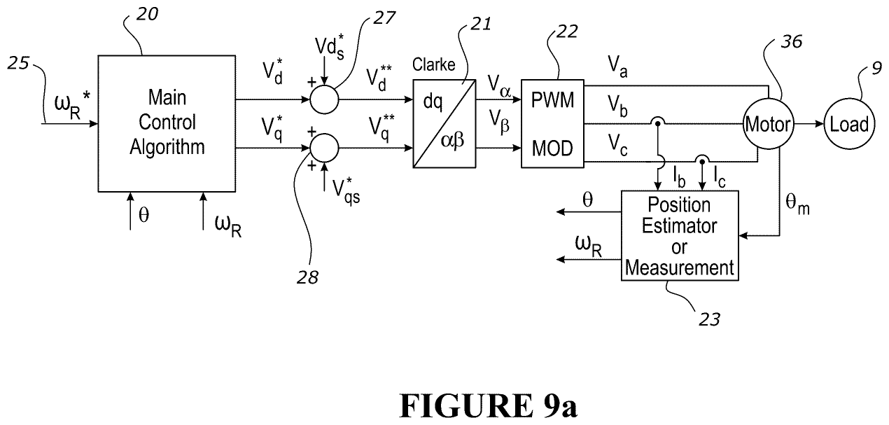

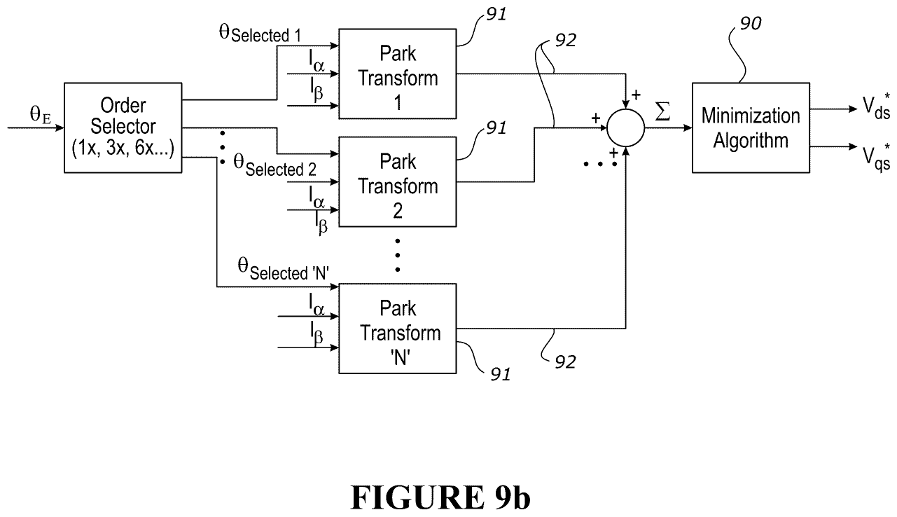

FIGS. 9a and 9b shows a further embodiment where feedback from the system is used without additional sensor requirements (i.e. only the expected sensors on the motor measuring motor position θm and electrical signals such as Ib and Ic. FIG. 9a illustrates the overall control system, which is similar to that shown in FIGS. 7 and 8. A suitable control algorithm or method can be connected from any of the measured signals to wither one of the injection signal points 27, 28, or elsewhere on the motor control signal. FIG. 9b shows how suitable injection signals (Vds* and Vqs*) can be generated. An error minimisation algorithm 90 is used to derive the cancellation signal or signals (for instance Vds* and Vqs*, or Vqs* alone, although the stationary or three phase signals could also be generated). The error minimization algorithm 90 calculates the signals required to minimise a calculated error signal. One or a plurality of signals are combined to form the error signal (ε). Each of the one or more signals may be generated based on the motor sensor measurements. Electrical motor measurements include voltage and current measurements as well as motor electrical position. Position measurements such as motor mechanical position or speed may also be used. In some cases, signals or measurements from the motor controller (such as driving signals or voltages may also be available).

It is possible to use the motor measurements or signals to calculate or measure harmonics present on the motor 36. FIG. 9b shows a Park transformation 91 used to generate the error signal (in this case the Park transformation 91 is inverted, or the inverse Park transformation 91 is used, stating from the alpha/beta fields). When harmonics of the motor electrical frequency θare applied to the Park transform 91, motor current harmonic of same electrical frequency, is converted into a DC component output 92 (along with an AC signal as expected). By filtering for and/or calculating the DC output 92 of one or more Park transforms 91 the torque ripple at harmonics or frequency multiples of the electrical frequency of the motor 36 can be obtained.

For instance, if we know that the 3^{rd} and 5^{th} harmonics of motor current are causes of noise at a particular motor 36 or drum 32 sped or rpm, we can use the electrical position of the 3^{rd} and 5^{th} harmonics (θselected1, θselected2) to generate two error signals. By minimising these error signals, the noise in the system will be reduced. The inputs to the inverse Park algorithm 91 are motor currents. In FIG. 9 the currents in the stationary phase are used (α, β). While a single harmonic (or input signal based on the motor electrical angle or speed) can be used it is also possible to use a plurality of signals (for instance N signals up to θselected‘N’). These signals can be generated by a multiple (integer or otherwise) of the fundamental electrical angle.

While the sensor-less system has been described using a Park transformation 91 (used inverted) any algorithm which is able to provide a signal representative of torque ripple, or a component thereof (such as cogging torque), could alternatively be used. Alternative signals could be generated by other parameters such as motor voltage, mechanical position or driving signals. A suitable transformation needs to produce, based on the available signals, an error signal which is dependent on, or indicative of, the noise produced by domestic appliance. This is possible because the motor provides the excitation for the noise, so with knowledge of when the motor excitation will resonate with components of the appliance the undesirable harmonics can be predicted, and using the methods described, reduced or cancelled.

The choice of orders or multiples to be minimized (both the number of orders and the multiples of the fundamental electrical frequency) can be a design choice based on experiments, such as determining which orders contribute the most to the minimization of the audible noise in the product containing the motor and load assembly. Considering the general operation of this control system, the electrical measurements (the current measurements Iα, Iβ) from the motor contain an indication of the vibration (and therefore noise) caused by the motor on the load (because the load is connected to the motor, so vibration of the load causes vibration of the motor). If the algorithm minimises any current/motor frequency that is of a different order of the one necessary on the main control algorithm (the fundamental one) can be minimized by this algorithm, and therefore, audible noise caused by them can be minimized accordingly.

1. A method of reducing the noise of a domestic appliance comprising a motor, the method comprising the steps of:
Obtaining a motor control signal configured to control the speed of the motor,
Obtaining a cancellation signal configured to reduce the noise of the domestic appliance,
Combining the motor control signal and the cancellation signal to form a combined signal, and
Applying the combined signal to the motor.

2. The method as claimed in claim 1, wherein the step of obtaining a cancellation signal comprises the steps of:
Identifying one or more frequencies of the domestic appliance; and
Calculating a cancellation signal dependent on the one or more frequencies.

3. The method as claimed in claim 2 wherein the step of identifying one or more frequencies comprises the step of:
Identifying one or more frequencies at each of one or more motor or load rotation speeds.

4. The method as claimed in claim 2 wherein the cancellation signal is configured to reduce the motor excitation which excites the identified one or more frequencies.

5. The method as claimed in claim 2 wherein the step of calculating a cancellation signal comprises the step of:
Calculating, or selecting, a harmonic of the electrical frequency associated with each of the identified frequencies.

6. The method as claimed in claim 2 wherein the step of identifying the one or more frequencies comprises:
Monitoring a noise level of the domestic appliance for a plurality of motor speeds.

7. The method as claimed in claim 2 wherein the step of identifying one or more frequencies comprises any one or more of the steps of:
Driving the motor at a plurality of motor driving frequencies or speeds;
Measuring a noise of the appliance at each of the plurality of frequencies or speeds; and
Identifying frequencies where noise levels are high relative to neighbouring frequencies.

8. The method as claimed in claim 2 wherein at least one, or each, of the one or more frequencies is a resonant frequency.

9. (canceled)

10. The method as claimed in claim 1 wherein the step of obtaining the cancellation signal comprises any one or more of:
Obtaining a phase of the cancellation signal,
Obtaining an amplitude of the cancellation signal,
Obtaining a frequency of the cancellation signal.

11. (canceled)

12. The method as claimed in claim 10 wherein the amplitude of the cancellation signal is 2-5% of the amplitude of the motor control signal.

13. The method as claimed in claim 10 wherein the step of obtaining a phase of the cancellation signal comprises any one or more of the steps of:
Loading a stored phase for the cancellation signal,
Testing one or more potential phases and selecting a phase from the tested phases,
Testing one, or a range of, potential phases and selecting a phase from the tested range of potential phases,
Adjusting a range of phases and using an optimisation function to select an optimum phase,
Adjusting the phase based on feedback from the domestic appliance, and/or
Adjusting the phase based on sensor measurements from the domestic appliance.

14. (canceled)

15. (canceled)

16. (canceled)

17. The method as claimed in claim 1 wherein the step of obtaining a cancellation signal comprises the steps of:
Calibrating a cancellation signal function, and
Generating a cancellation signal based on the cancellation signal function.

18. The method as claimed in claim 17 wherein the step of calibrating the cancellation signal function comprises the steps of:
Obtaining noise data of the domestic appliance, and
At one or more frequencies obtaining signal parameters for cancellation signal.

19. The method as claimed in claim 18 wherein the signal parameters include any one or more of phase, amplitude, or frequency.

20. The method as claimed in claim 19 wherein the signal parameters of amplitude and/or frequency are preconfigured and the signal parameter for phase is configurable.

21. (canceled)

22. (canceled)

23. (canceled)

24. The method as claimed in claim 1, wherein the step of obtaining the cancellation signal comprises:
Obtaining a feedback signal, and
Generating the cancellation signal based on the feedback signal.

25. (canceled)

26. (canceled)

27. A method as claimed in claim 1, wherein the step of obtaining the cancellation signal comprises:
Identifying noise produced by the domestic motor driven appliance, and
Calculating a cancellation signal configured to reduce the excitation of a motor frequency producing the noise.

28. A method as claimed in claim 27 wherein the step of calculating a cancellation signal comprises any one or more of:
A look-up table,
A look-up table linking undesirable noise parameters to cancellation signal parameters,
A look-up table linking motor parameters to cancellation signal parameters,
Minimising a feedback signal,
Minimising a sound feedback signal, and/or
Minimising a vibration feedback signal.

29. (canceled)

30. A method as claimed in claim 2 wherein the frequencies of the domestic appliance are determined from the domestic appliance characteristics, the characteristics including any one or more of:
Motor dimensions,
Motor Cogging,
Drum Volume, Diameter, Depth
Fan Size,
Motor Type, and/or
Load Size, Load Type or Load Weight.

31. (canceled)

32. (canceled)

33. (canceled)

34. A domestic appliance comprising:
A load,
A motor configured to operate the load, and
A controller configured to:
Obtain a motor control signal configured to control the speed of the motor,
Obtain a cancellation signal configured to reduce the noise or vibration of the domestic appliance,
Combine the motor control signal and the cancellation signal to form a combined signal, and
Apply the combined signal to the motor.

35. (canceled)

36. (canceled)
